(19) United States
(12) Patent Application Publication
(10) Pub. No.: US 2021/0298986 A1
(43) Pub. Date: Sep. 30, 2021

(54) STICK, METHOD OF CONTROLLING STICK, AND PROGRAM

(71) Applicant: Toyota Jidosha Kabushiki Kaisha, Toyota-shi Aichi-ken (JP)

(72) Inventors: Eisuke Aoki, Toyota-shi (JP); Tadashi Odashima, Toyota-shi (JP); Eiji Tsuchiya, Nagakute-shi (JP); Yoshihiro Mizuno, Nagakute-shi (JP); Ryo Koyama, Nagakute-shi (JP); Hidekazu Nishigaki, Nagakute-shi (JP)

(21) Appl. No.: 17/215,461

(22) Filed: Mar. 29, 2021

(30) Foreign Application Priority Data
Mar. 30, 2020 (JP) 2020-059949

(51) Int. Cl. A61H 3/04

(52) U.S. Cl. CPC A61H 3/04; A61H 2201/5069; A61H 2003/043; A61H 2201/5025; A61H 2201/5097

(57) ABSTRACT

A stick capable of assisting walking by power of a wheel and driving the wheel according to user's desire regarding walking while maintaining the stick at a stable posture is provided. A stick includes a first stick with a wheel and a second stick with a wheel, in which the first stick and the second stick are made to cooperate with each other to control driving of the wheels included in the first stick and the second stick, respectively.

### CROSS REFERENCE TO RELATED APPLICATIONS

This application is based upon and claims the benefit of priority from Japanese patent application No. 2020-059949, filed on Mar. 30, 2020, the disclosure of which is incorporated herein in its entirety by reference.

### BACKGROUND

The present disclosure relates to a stick, a method of controlling a stick, and a program.

Japanese Unexamined Patent Application Publication No. 2007-244535 discloses a stick to be used for assistance or training for walking, the stick including a wheel part and a ferrule part, both of which contact the ground surface when the stick is in a supporting state.

### SUMMARY

However, in the stick disclosed in Japanese Unexamined Patent Application Publication No. 2007-244535, it is required to move the stick only by power of a user. Therefore, there has been a demand for a stick capable of assisting walking by power of a wheel, and in particular, a stick capable of driving the wheel according to user's desire regarding walking while maintaining the stick at a stable posture.

An object of the present disclosure is to provide a stick capable of assisting walking by power of a wheel and driving the wheel according to user's desire regarding walking while maintaining the stick at a stable posture, a control method thereof, and a program.

A stick according to one aspect of the present disclosure to accomplish the above object includes; a first stick with a wheel and a second stick with a wheel, in which the first stick and the second stick are made to cooperate with each other to control driving of the respective wheels included in the first stick and the second stick. According to this aspect, it is possible to not only obtain high stability with the two sticks but also assist walking by power of the wheels and also it becomes possible to drive the wheels according to user's desire regarding walking while maintaining the sticks at a stable posture by the cooperated control.

Further, the first stick may include a first grip part that a user grasps, the second stick may include a second grip part that the user grasps, the stick may include a switch that is provided in one of the first grip part and the second grip part, the switch being turned on when the user presses the switch by grasping the one of the first and second grip parts, and the stick may start the drive control when the switch is turned on. Accordingly, since the driving of the wheels is controlled as the switch is turned on, it becomes possible to drive the wheels according to user's desire regarding walking.

The stick may perform the drive control during a period in which the switch is in the ON state. Accordingly, the stop control by the switch being turned off can be employed, and when the switch is turned off due to some accident such as user's overturn, the driving of the both wheels can be stopped, which enables the user to use the stick more safely. Further, accordingly, it is possible to not only perform the sudden stop control but also prevent the size of the stick from increasing compared to a case in which a brake is separately provided.

Further, the first stick may include a first grip part that a user grasps and a first switch that is provided in the first grip part and is turned on when the user who grasps the first grip part presses the first switch, the second stick may include a second grip part that the user grasps and a second switch that is provided in the second grip part and is turned on when the user who grasps the second grip part presses the second switch, and the stick may start the drive control in accordance with an ON state of the first switch and the second switch. Accordingly, since the drive control of the wheels is started based on the switch which is in the ON state, it becomes possible to drive the wheels according to user's desire regarding walking.

The stick may start the drive control when both the first switch and the second switch are turned on. Accordingly, since the driving of the wheels is controlled as the both switches are turned on, it becomes possible to drive the wheels according to user's desire regarding walking.

Further, the stick may perform the drive control during a period in which both the first and second switches are in the ON state. Accordingly, when one of the switches is turned off due to some accident such as user's overturn, the driving of the both wheels can be stopped, which enables the user to use the stick more safely. Further, accordingly, it is possible to not only perform the sudden stop control but also prevent the size of the stick from increasing compared to a case in which a brake is separately provided.

Further, a setting part may be configured to disable one of the first switch and the second switch, in which the stick may start the drive control when all the effective switches of the first and second switches are turned on. Accordingly, since the driving of the wheels is controlled as the effective switches are turned on, it becomes possible to drive the wheels according to user's desire regarding walking, and the user can use the stick appropriately depending on the state of the leg part of the user.

Further, the stick may perform the drive control during a period in which all the effective switches are in the ON state. Accordingly, when the effective switch is turned off due to some accident such as user's overturn, the driving of the both wheels can be stopped, which enables the user to use the stick more safely. Further, accordingly, it is possible to not only perform the sudden stop control but also prevent the size of the stick from increasing compared to a case in which a brake is separately provided.

Further, the first stick may include a first sensor configured to detect inclination of the first stick, the second stick may include a second sensor configured to detect inclination of the second stick, and the drive control may be performed based on the inclination detected by the first sensor and the inclination detected by the second sensor. Accordingly, it becomes possible to drive the wheels according to user's desire regarding walking while maintaining the stick at a more stable posture.

Further, the first stick and the second stick are connected to each other by a wired cable or wireless communication. Accordingly, sticks having various forms and applications may be provided.

In a method of controlling a stick according to another aspect of the present disclosure, the stick includes a first stick with a wheel and a second stick with a wheel, and the first stick and the second stick are made to cooperate with each other to control driving of the respective wheels included in the first stick and the second stick. According to this aspect, it is possible to not only obtain high stability with the two sticks but also assist walking by power of the wheels and also it becomes possible to drive the wheels according to user's desire regarding walking while maintaining the sticks at a stable posture by the cooperated control.

A program according to another aspect of the present disclosure is a program for causing a computer included in a stick to execute wheel driving processing, in which the stick includes a first stick with a wheel and a second stick with a wheel, and in the wheel driving processing, the first stick and the second stick are made to cooperate with each other to control driving of the respective wheels included in the first stick and the second stick. According to this aspect, it is possible to not only obtain high stability with the two sticks but also assist walking by power of the wheels and also it becomes possible to drive the wheels according to user's desire regarding walking while maintaining the sticks at a stable posture by the cooperated control.

According to the present disclosure, it is possible to provide a stick, capable of assisting walking by power of a wheel and driving the wheel according to user's desire regarding walking while maintaining the stick at a stable posture, a control method of the stick, and a program.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic perspective view showing one configuration example of a stick according to a first embodiment;

FIG. 2 is a block diagram showing one example of a control system of the stick according to the first embodiment;

FIG. 3 is a schematic perspective view showing a state in which a user puts his/her left hand ahead of the right hand in the stick shown in FIG. 1;

FIG. 4 is a flowchart for describing a processing example in the stick shown in FIG. 2;

FIG. 5 is a flowchart for describing a processing example in a stick according to a second embodiment;

FIG. 6 is a schematic perspective view showing one configuration example of a stick according to a third embodiment; and

FIG. 7 is a diagram showing one example of a hardware configuration of a stick with a wheel.

### DESCRIPTION OF EMBODIMENTS

Hereinafter, the present disclosure will be described based on embodiments of the present disclosure. However, the disclosure set forth in claims is not limited to the following embodiments. Moreover, it is not absolutely necessary to provide all the configurations to be described in the following embodiments as means for solving the problems. Hereinafter, with reference to the drawings, embodiments will be described.

### First Embodiment

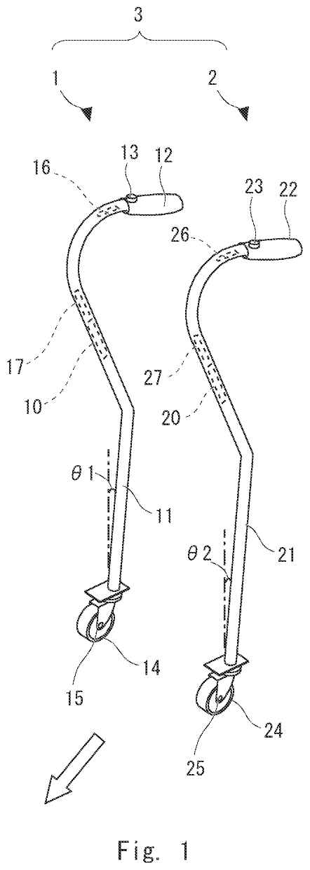

With reference to FIGS. 1 to 4, a first embodiment will be described. FIG. 1 is a schematic perspective view showing one configuration example of a stick according to this embodiment.

As shown in FIG. 1, a stick 3 with a wheel according to this embodiment includes a first stick 1 with a wheel 14 and a second stick 2 with a wheel 24. The first stick 1 and the second stick 2 have basically the same structure. They are used in such a way that they are symmetrical, or the first stick 1 is symmetrical and the second stick 2 is also symmetrical and either the left stick or the right stick may be used. The stick 3 may be referred to as a stick set or two sticks.

The first stick 1 may include a controller 10, a body frame 11, a grip part 12, a switch 13, a wheel 14, a drive part 15, a sensor 16, and a communication unit 17. The second stick 2 may include a controller 20, a body frame 21, a grip part 22, a switch 23, a wheel 24, a drive part 25, a sensor 26, and a communication unit 27.

Note that the grip part 12 and the grip part 22 are respectively a first grip part and a second grip part included in the stick 3, the switch 13 and the switch 23 are respectively a first switch and a second switch included in the stick 3, and the sensor 16 and the sensor 26 are respectively a first sensor and a second sensor included in the stick 3. Further, the drive part 15 and the drive part 25 are respectively a first drive part and a second drive part included in the stick 3 and the wheel 14 and the wheel 24 are respectively a first wheel and a second wheel included in the stick 3. The same goes true for the body frames 11 and 21 and the communication units 17 and 27.

In the following description, only components of the first stick 1 will be mainly described. Basically, the same goes true for the components of the second stick 2.

While the body frame 11 may be, for example, a member having a cylindrical shape, the shape thereof is not limited thereto. The body frame 11 may have a bent shape as shown in FIG. 1 or may have a linear shape. Further, the cross-sectional shape thereof is not limited to a circular shape. The grip part 12, which is a part that the user can grip, may be provided above the body frame 11 and the body frame 11 and the grip part 12 may be integrally formed. While the grip part 12 basically has such a form that the user can grasp it with one hand, the user can grasp the grip part 12 with both hands in some cases. The shape of the grip part 12 is not limited. When the body frame 11 has a linear shape, the grip part 12 may be attached above the body frame 11 so that the body frame 11 and the grip part 12 may form a T shape.

The switch 13, which is a switch provided in the grip part 12, may either be a mechanical switch or an electronic switch such as a pressure sensor. In some embodiments, the switch 13 is provided in such a position that it can be pressed (or touched) by the user when the user grasps the grip part 12. As a matter of course, while the gripping method when the user actually uses the first stick 1 may be different for each user, the switch 13 may be provided in such a position that it can be pressed or touched by at least a general user. The applications of the switch 13 will be described later.

The drive part 15, which is a part that drives the wheel 14, may include, for example, a motor although the mechanism or the like thereof is not limited. Hereinafter, a description will be given of the drive part 15 which includes a motor as a main component thereof. The drive part 15 may be provided, for example, below the body frame 11, and a part indicated by the number 15 indicates the drive shaft part thereof.

The wheel 14, which is a wheel that can be rotated along the ground, can be attached to the drive shaft of the drive part 15. That is, the wheel 14 may be a driving wheel driven by the drive part 15. The wheel 14 may include a tire made of rubber, a soft iron or the like in a part of the wheel 14 that contacts the ground. Although it is sufficient that one wheel 14 be provided in the first stick 1, a plurality of wheels 14 may instead be provided in the first stick 1 (e.g., two wheels 14 may be provided so as to sandwich the body frame 11 in FIG. 1). By providing two or more of the wheels 14, the user is able to perform stable walking. When, for example, two wheels 14 are provided on the right and left, a control to change the moving direction may be performed by adjusting the torque amount of the right wheel and the torque amount of the left wheel.

The sensor 16, which is a sensor that detects the inclination of the first stick 1, may be provided, for example, inside the body frame 11. While the sensor 16 may be, for example, an acceleration sensor, an optical sensor or the like, this embodiment is not limited thereto. As described above, the switch 13 is disposed in the grip part 12 and is turned on by the user who grasps the first stick 1 pressing this switch 13. Further, the switch 13 may have a noticeable shape so that the user is able to recognize it or the color of the switch 13 may be different from the other parts of the stick. Alternatively, a power supply switch for functioning a control system may be provided separately from the switch 13.

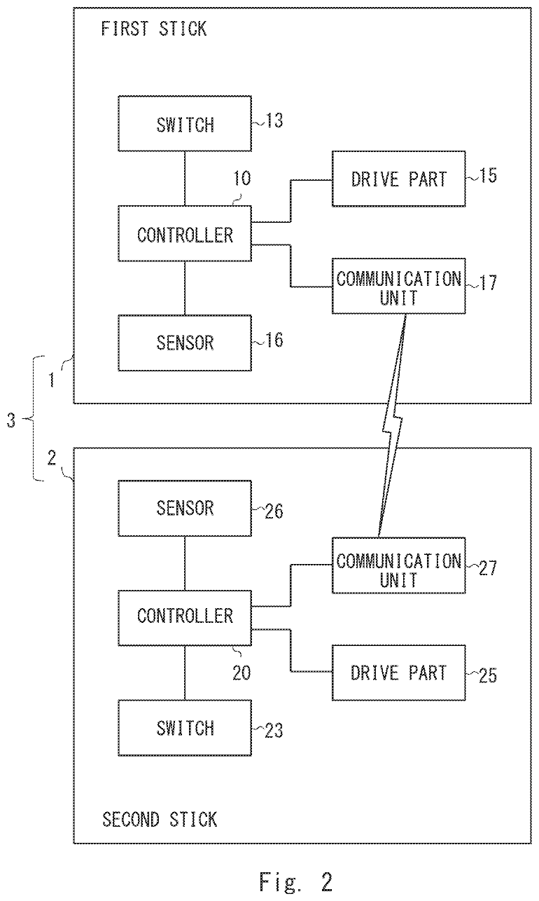

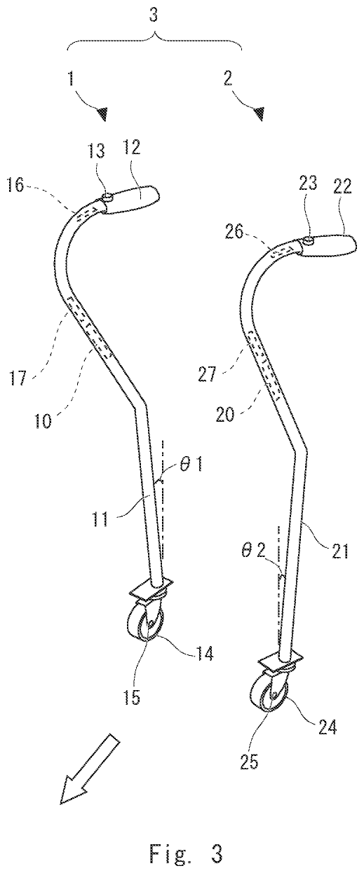

With reference also to FIGS. 2 and 3, control in the controllers 10 and 20 will be described. FIG. 2 is a block diagram showing one example of a control system of the stick 3 according to this embodiment. FIG. 3 is a schematic perspective view showing a state in which the user puts the left hand ahead of the right hand in the stick 3 shown in FIG. 1.

As shown in FIG. 2, the controller 10 may be connected to the switch 13, the drive part 15, and the sensor 16 and can be formed so as to control the entire first stick 1. The controller 10 is achieved by, for example, a processor such as a Central Processing Unit (CPU), a working memory, and a non-volatile storage device, or by an integrated circuit. This storage device may store a program for control executed by the processor and the processor may load this program to the working memory and execute this program, whereby the function of the controller 10 may be achieved. The controller 20 may have a configuration similar to that of the controller 10, and the entire second stick 2 may be controlled.

In the stick 3 according to this embodiment, the first stick 1 and the second stick 2 cooperate with each other to control driving of the wheels 14 and 24 included in the first stick and the second stick 2, respectively. The aforementioned cooperation may be achieved by the controller 10 controlling the drive parts 15 and 25 in such a way that the wheel 14 and the wheel 24 are driven in a cooperated manner (accordingly, the inclination of the stick 3 is also controlled in a cooperated manner).

Further, the above cooperation may be achieved by a wired or wireless communication in the communication units 17 and 27. In this case, control may be performed using one of the controllers 10 and 20 as a master and the other one of the controllers 10 and 20 as a slave while performing communication between the communication units 17 and 27. However, the master and the slave may be switched depending on the settings or may be switched for each control timing (e.g., the one in which the switch is turned on serves as a master at that point). In the following description, for the sake of simplification of the description, an example in which control is always performed using the controller 10 as a mater and the controller 20 as a slave will be described.

When the communication units 17 and 27 are wired communication units, a wired cable (not shown) may be laid between the first stick 1 and the second stick 2. When the communication units 17 and 27 are wireless communication units, this wired cable is not necessary since the first stick 1 and the second stick 2 can be connected to each other by wireless communication.

The stick 3 according to this embodiment may start drive control in accordance with the ON state of the switches 13 and/or 23. In this case, the controller 10 obtains an input from the switch 13 and obtains information indicating the state of ON/OFF of the switch 23 from the controller 20 via the communication units 17 and 27, and starts the drive control in accordance with the ON state. The ON state here includes a case in which both the switches are in the ON state and a case in which only one of the switches is in the ON state, and an example will be described later.

Further, the above drive control may be performed based on the inclination detected by the sensor 16 and the inclination detected by the sensor 26. In this case, the controller 10 obtains an input from the sensor 16 and obtains an input of the sensor 26 from the controller 20 via the communication units 17 and 27, and controls the drive parts 15 and 25 based on these inclinations (detection values). The controller 10 executes control of the drive part 25 via the communication units 17 and 27 and the controller 20.

As an example, the controller 10 starts the above drive control when the switches 13 and 23 are both turned on. In particular, when the switches 13 and 23 are both turned on, the controller 10 controls the drive parts 15 and 25 based on the inclination detected by the sensor 16 and the inclination detected by the sensor 26. That is, the controller 10 controls driving of the wheels 14 and 24 by controlling the drive parts 15 and 25 based on the inclinations detected in the sensors 16 and 26 when the switches 13 and 23 are both turned on. While a specific control method is not limited, a control algorithm in which the user's walking is taken into account may be employed. For example, the controller 10 is able to control the drive part 15 by giving a larger weight to the detection value from the sensor 16 among the sensors 16 and 26 and control the drive part 25 by giving a larger weight to the detection value from the sensor 26 among the sensors 16 and 26.

A case in which, for example, the user moves the first stick 1 and the second stick 2 by applying forces so that the left hand is put ahead (forward moving direction) of the right hand as shown in FIG. 3 from a state in which the inclinations θ1 and θ2 detected by the sensors 16 and 26 are the same as shown in FIG. 1 will be described. In this case, the controller 10 controls the drive part 15 to increase the rotation speed of the wheel 14 and controls the drive part 25 to decrease the rotation speed of the wheel 24.

In this state, since it is normal for the user to advance the leg on the side where the hand is located in the rear side (in this case, the right leg) with respect to the leg on the side where the hand is located in the front side (in this case, the left leg) after or concurrently with the above operation, the above control is performed. While θ1 shows a state in which the body frame 11 is inclined forward and θ2 shows a state in which the body frame 21 is inclined backward in FIG. 3 for the sake of convenience, both the body frame 11 and the body frame 21 may be inclined forward or backward depending on the user.

While θ1 and θ2 are both defined to be angles with respect to the vertical direction, the embodiment is not limited thereto. As a matter of course, an azimuth angle may be taken into account. By taking the azimuth angle into account, it is possible to perform control so as to maintain the distance between the first stick 1 and the second stick 2 in the right-left direction that is perpendicular to the forward moving direction, that is, to keep the width between the first stick 1 and the second stick 2 to be constant. The same holds true for the definition of the other angles described below.

Further, when the right hand is put ahead of the left hand, the control that is opposite to the aforementioned control may be performed. Further, changes in the rotation speed of the wheels 14 and 24 may be generated by changes in the angular velocity or the angular acceleration of the rotation of the wheels 14 and 24, respectively, and how they are changed varies depending on the control system to be implemented.

Further, the controller 10 is also able to control the rotation of the wheels 14 and 24 with the horizontal movement speed relative to the actual ground as a target. For example, the controller 10 may perform control in such a way that the user can simply move at a constant speed on the ground. In this case, when the inclinations coincide with each other or the difference between the inclinations becomes so large that it exceeds a threshold, the controller 10 may stop control so as to stop the movement, assuming that the former case corresponds to a normal walking stop and the latter case corresponds to overturn. Further, in any control method, the controller 10 is able to perform control so as to change the moving direction by adjusting the torque amount of the right wheel 14 and the torque amount of the left wheel 24.

While the forward moving direction is shown by the white arrows in FIGS. 1 and 3, the controllers 10 and 20, the wheels 14 and 24, and the drive parts 15 and 25 may be configured in such a way that backward movement may be performed as well. When the backward movement is performed, a control method in which control by the inclinations θ1 and θ2 is stopped may be employed.

Further, the controller 10 is also able to control the drive parts 15 and 25 so as to maintain the inverted state of the stick 1 based on θ1 and θ2 detected by the sensors 16 and 26 (that is, perform inverted pendulum control). Accordingly, the user is able to walk while the angle of the body frame 11 of the stick 1 is controlled to be kept constant and stable. This inverted pendulum control is also one example for controlling the drive parts 15 and 25 by cooperating them based on the inclinations θ1 and θ2 and may be combined with another control. Further, the inverted state may be a state in which the body frames 11 and 21 are directed toward the vertical direction or may be based on an angle inclined forward or backward by a predetermined angle.

In some embodiments, the sensors 16 and 26 are provided in the vicinity of the grip part 12 as illustrated in FIG. 1 or in the grip part 12. By providing the sensors 16 and 26 in such a way that they are provided near the hands of the user, the changes in the inclinations θ1 and θ2 become large depending on the force of the user (or the amount of movement), as a result of which the changes in the inclinations θ1 and θ2 may be easily detected and fine control may be performed. Further, accordingly, the acceleration of the moving direction is hard to be detected in the sensors 16 and 26 and there is no need to provide a gyro function in the sensors 16 and 26.

Hereinafter, a control method according to this embodiment (hereinafter referred to as this method) that may be executed in the stick 3 will be described. This method is a method of controlling the stick 3, more specifically, a method of controlling the drive parts 15 and 25, in which the first stick 1 and the second stick 2 are made to cooperate with each other to perform drive control of the wheels 14 and 24 included in the first stick 1 and the second stick 2, respectively. While this control method may be achieved, for example, by using the above program for causing a computer provided in the master side of the controllers 10 and 20 (one or both) of the stick 3 to execute the wheel driving processing described below, this embodiment is not limited thereto. The above-described wheel driving processing is processing of cooperating the first stick 1 with the second stick 2 to control driving of the wheels 14 and 24 included in the first stick 1 and the second stick 2, respectively. Another example of the control method and the program has been described above or will be described later.

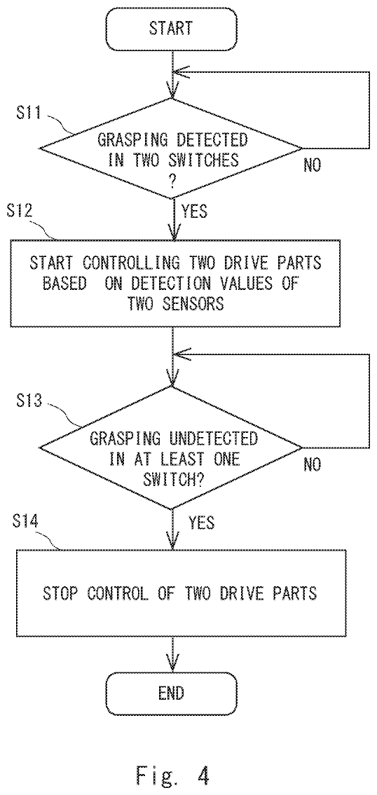

With reference to FIG. 4, examples of the above control method will be described. FIG. 4 is a flowchart for describing a processing example in the stick 3. First, it is assumed that the controller 10 monitors the states of the switches 13 and 23 and the detection values, which are the output values from the sensors 16 and 26 (the inclinations θ1 and θ2). The controller 10 determines whether or not the grasping operation by the user has been detected in both the switches 13 and 23 (Step S11), and when it has been detected, the processing moves to the following processing.

When it has been determined to be YES in Step S11 (when the grasping operation in both the switches has been detected), the controller 10 starts controlling the drive parts 15 and 25 based on the detection values of the sensors 16 and 26 (Step S12). Next, the controller 10 determines whether or not the grasping operation has become undetected in at least one of the switches 13 and 23 (Step S13). When the grasping operation has become undetected (when it has been determined to be YES), the control of the drive parts 15 and 25 is stopped (Step S14). Accordingly, the driving of the wheels 14 and 24 is stopped when the user no longer grasps at least one of the sticks.

The above processing is repeated. That is, after Step S14, the processing is started again from Step S11.

As illustrated in the processing of Step S13 and the subsequent processing, the switches 13 and 23 may be switches that are turned off when the user stops the grasping operation. In this case, the controller 10 may control the drive parts 15 and 25 so as to stop driving the wheels 14 and 24 when at least one of the switches 13 and 23 is turned off. That is, the switches 13 and 23 may serve as switches for stopping the wheels 14 and 24 as an emergency when the user releases his/her hand therefrom.

In other words, the controller 10 may perform the drive control during the period in which the switches 13 and 23 are both in the ON state. Accordingly, when one of the switches is turned off due to some accident such as user's overturn, it is possible to stop the driving of both the wheels 14 and 24 and thus enable the user to use the stick 3 more safely.

As described above, with the stick 3 according to this embodiment, it is possible to not only obtain high stability with the two sticks but also assist walking with the power of the wheels 14 and 24, and it becomes possible to drive the wheels 14 and 24 according to user's desire regarding walking while maintaining the stick 3 at a stable posture. In particular, in the stick 3, the pair of sticks 1 and 2 are positioned in the right and left side of the user, whereby the user is able to use the stick in a stable stick posture state while stabilizing the posture in the right-left direction.

The stick 3 starts/stops the driving by turning on/off the switches 13 and 23, whereby the stick 3 is able to move/stop (according to user's desire) while reflecting user's desire regarding movement. The stick 3 starts the driving when the switches 13 and 23 are both turned on, which enables the user to move with the stick 3 when the user wants to move. Further, the stick 3 can be used in a stable stick posture state by performing the drive control by the inclinations θ1 and θ2. As described above, the stick 3 is able to drive, for example, the wheels 14 and 24 at a desired speed (walking speed) so that the user can move in the direction that the user wants to move and stop driving the wheels 14 and 24 so that the user can stop when the user wants to stop.

The effects of the stop control when the switch 13 or the switch 23 is turned off will be additionally described.

In a stick that simply includes a wheel, a body frame, and a grip part, it may be possible to provide a brake in order to generate a braking force. However, in order to make the load applied to the brake large, the distance between the wheel and the brake needs to be increased, which causes an increase in the size of the stick. On the other hand, by employing the stop control performed when the switch 13 or the switch 23 is turned off according to this embodiment, it is possible to prevent the size of the stick from increasing and to further perform sudden stop control. Further, when a motor is provided, it is possible to generate a braking force in the wheel by controlling the motor. However, it can be extremely dangerous if the motor control is disabled due to some error. On the other hand, by employing the stop control performed when the switch 13 or the switch 23 is turned off like in this embodiment, it is possible to avoid such danger.

The effects of the drive control by the inclinations θ1 and θ2 will be additionally described.

When a user uses a stick that simply includes a wheel, a body frame, and a grip part, the user needs to apply a power to carry the stick in a part of the walking period (a period of an operation of putting the stick again on the ground). Further, when the user walks while using the stick, the operation of putting the stick again on the ground in accordance with the walking produces time during which the user does not put the stick on the ground, which causes a heavy burden on the knee during the movement and the user may easily lose his/her balance.

On the other hand, with the stick 3 according to this embodiment, it is possible to not only obtain high stability using the two sticks 1 and 2 but also move the stick 3 as if the stick 3 follows the user's walking by assisting the user's force. That is, with the stick 3, there is no need for the walking person to adjust the moving speed of the stick 3, and the stick is moved in accordance with the walking. Further, the above operation may be performed in the stick 3 without performing particularly complicated sensing or complicated control. This is due to the following reason. That is, when the user's body moves with the user having the stick 3 in his/her hand, the wrist corresponds to a hinge structure and the stick and the arm correspond to a link structure, and the inclination θ1 of the first stick 1 and the inclination θ2 of the second stick 2 are changed. Therefore, by performing control so as to correct these inclinations θ1 and θ2, the user can automatically feel as if he/she is moving while maintaining the distance from his/her body.

Further, it may be possible to generate a driving force in a stick that simply includes a wheel, a body frame, and a grip part by employing a passive wheel. When the passive wheel is employed, the user walks in a state in which the stick is inclined toward the user since the stick is moved by the user's force. When the user walks with the stick having this structure, a load is applied to the stick, which is likely to cause the stick to slide. In this case, the operation of the stick could be dangerous unless any countermeasure against this danger is taken on a method of generating a braking force. On the other hand, in the stick 3 according to this embodiment, the wheels 14 and 24 are configured to be driven by the drive parts 15 and 25, respectively, that is, they are configured to include the driving wheels, which eliminates the need of taking the countermeasure against the above danger.

Further, when a stick is driven by a motor or the like in order to generate a driving force in a stick that simply includes a wheel, a body frame, and a grip part, it may be possible to control the movement of the stick (perform operation) by the user by adjusting the speed of the motor by an operation switch or the like while walking. This can be dangerous for the user if he/she is not accustomed to this operation. On the other hand, in the stick 3 according to this embodiment, the driving of the wheels 14 and 24 is controlled based on the inclinations θ1 and θ2, which eliminates the need of taking the countermeasure against the above danger. Further, when the motor requires a large driving force for a long time, the capacity of a battery to be mounted on the motor becomes large and the size of the battery increases as well. However, with the stick 3 according to this embodiment, even when the motors are used as the drive parts 15 and 25, although the speed is controlled by these motors, the driving of the motors can be minimized since the control is limited to the drive control based on the inclinations θ1 and θ2. Accordingly, according to this embodiment, a power source such as a battery can be minimized.

Further, in this embodiment, the drive parts 15 and 25 may respectively drive the wheels 14 and 24 by a transmission mechanism that lacks backdrivability. The transmission mechanism that lacks backdrivability may be, for example, a mechanism that includes a worm drive (worm gear). By using the worm gear, for example, a structure in which the driving can be performed from the motor but reverse drive from the side of the tire cannot be performed may be employed. However, the above-mentioned transmission mechanism is not limited to the worm gear and a known technology may be used. The worm gear eliminates backdrivability with a simple structure. As a matter of course, the expression “lacks backdrivability” indicates that it can be regarded that the transmission mechanism substantially lacks backdrivability.

By employing the transmission mechanism that lacks backdrivability as described above, even when the user suddenly wants to stop walking, the rotation of the wheels 14 and 24 can be immediately stopped in accordance the user's motion. That is, by employing the transmission mechanism that lacks backdrivability, the tires can be automatically locked except when the user is walking (or when a large external force is applied while the user is walking), and thus it is possible to prevent danger such as user's overturn. In particular, this transmission mechanism brings about larger effects when the example in which the switch 13 or the switch 23 is configured so as to be turned off when the user stops gripping the grip parts is employed besides the transmission mechanism.

Further, in this embodiment, when a load is applied in the state in which the first stick 1 or the second stick 2 is inclined toward the user, the motor receives a power on the regenerative side. However, since the stick can be locked by employing the aforementioned transmission mechanism such as a worm gear, the stick does not move in a state in which the motor is not driven. When the motor is driven from this state, the lock can be released, which enables the first stick 1 or the second stick 2 to move forward only by the driving force. Therefore, by employing the above transmission mechanism in this embodiment, it is possible to reduce the consumption of the energy when the stick is stopped and to make the consumption of the energy when the stick is stopped zero by performing better control.

It is sufficient that the stick 3 according to this embodiment include the drive parts 15 and 25 that respectively drive the wheels 14 and 24 by a transmission mechanism that lacks backdrivability and may not include, for example, one or both of the switches 13 and 23 and the sensors 16 and 26. By simply providing the wheels 14 and 24 and the drive parts 15 and 25, it becomes possible to obtain effects that it is possible to assist walking by the power of the wheels 14 and 24 and drive the wheels 14 and 24 according to user's desire regarding walking. As a matter of course, certain effects can be obtained to some extent by just including a transmission mechanism having low backdrivability as the drive parts 15 and 25.

Further, the stick 3 may include a setting part that disables one of the switches 13 and 23 and may be configured to start the drive control when all the effective switches of the switches 13 and 23 are turned on. This setting part may be included in the controller 10 or in both the controllers 10 and 20 for the switches 13 and 23, respectively. In the latter case, the controller 10 is able to obtain the setting of enabling/disabling of the switch 23 via the communication units 17 and 27. By providing the setting part, it becomes possible to use the stick 3 appropriately in accordance with the state of the leg part or the like of the user. Further, since the drive control is started when all the effective switches are turned on, it becomes possible to drive the wheels 14 and 24 according to user's desire regarding walking.

As described above, when the stick 3 includes a function of disabling at least one switch, the controller 10 may perform the drive control during the period in which all the effective switches are in the ON state. That is, in this case, the controller 10 stops the drive control at a timing when all the effective switches are turned off (a timing when one of the effective switches is turned off becomes similar to that in the control in FIG. 4).

Further, while the stick 3 includes the first stick 1 and the second stick 2, the first stick 1 and the second stick 2 may each be used alone as a stick with one wheel. Therefore, when the method in which only one of the sticks is used is employed, this method may be set in the internal memory. Further, it may be determined that only one stick is used when, for example, the communication between the communication units 17 and 27 cannot be performed. In this case, it may be possible to perform control for the use of only one stick.

As described above, the example in which the switches (the switches 13 and 23) are respectively provided in the grip part 12 and the grip part 22 has been described in this embodiment, a switch may be provided in only one of the grip parts.

The above example will be briefly described taking a case in which the switch 23 is not provided and only the switch 13 is provided as an example. In this case, the stick 3 starts the drive control when the switch 13 is turned on. This drive control and the start thereof are performed by the controller 10. The controller 10 drives the wheel 14 by performing the drive control of the drive part 15, and drives the wheel 24 by causing the controller 20 to execute the drive control of the drive part 25 via the communication units 17 and 27. Further, in this case, the stick 3 may be configured to perform the above drive control during the period in which the switch 13 is in the ON state. Regarding other examples, the control is performed in a way basically similar to the case in which the switches are provided in the respective sticks.

### Second Embodiment

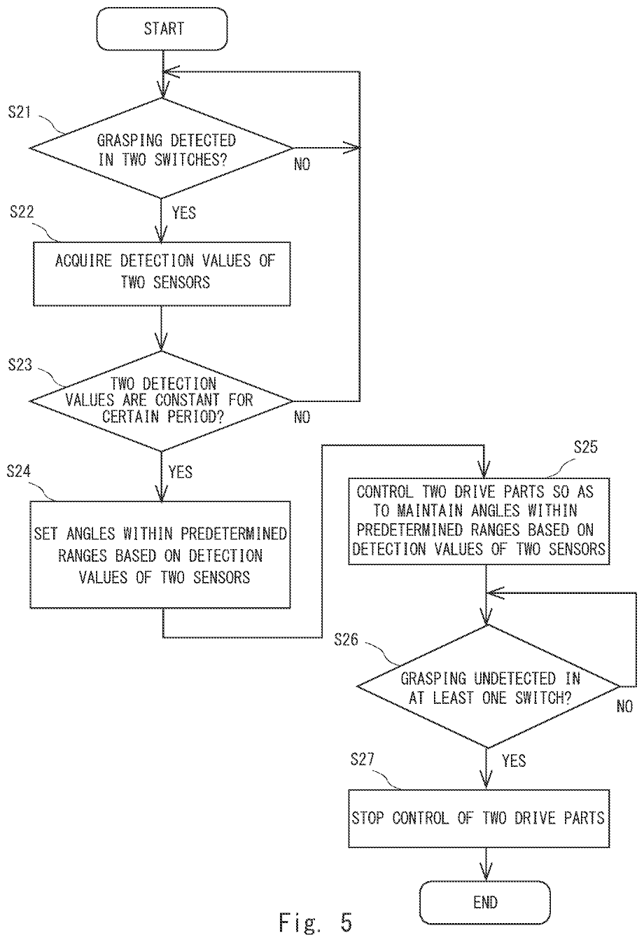

While a second embodiment will be described with reference to FIG. 5, focusing the differences from the first embodiment, various application examples described in the first embodiment may be applied to the basic structure of the stick 3 etc. FIG. 5 is a flowchart for describing a processing example in the stick according to this embodiment.

The stick 3 according to this embodiment may have a structure as described in FIG. 1. However, the control performed by the controller 10, which is an example of the controller serving as a master in the stick 3 according to this embodiment is different from that in the first embodiment. Further, the stick 3 according to this embodiment may not necessarily include the switches 13 and 23 and may include, as a control system, controllers 10 and 20, drive parts 15 and 25, and sensors 16 and 26.

The controller 10 according to this embodiment controls the drive part 15 and the drive part 25 in such a way that an inclination θ1 detected by the sensor 16 maintains an angle in a predetermined range (θ1a-θ1b) and an inclination θ2 detected by the sensor 26 maintains an angle in another predetermined range (θ2a-θ2b). Such a control is the one described as inverted pendulum control in the first embodiment. When, for example, the vertical direction is set as a reference (when control is performed so that the body frames 11 and 21 are directed toward the vertical direction), θ1a=−θ1b (an intermediate angle between θ1a and θ1b is set to) 0° and θ2a=−θ2b (an intermediate angle between θ2a and θ2b is set to 0°) may be established.

Further, while θ1a=θ2a and θ1b=θ2b are established, when a user who has only one diseased leg of the two legs is taken into account, these values be configured in such a way that they can be set in the internal memory. That is, the stick 3 according to this embodiment may include a setting part configured to set the above angles within the predetermined ranges. This setting part may be included in the controller (the controller 10, or both the controllers 10 and 20). This setting part may be configured in such a way that an operation part that accepts an operation from the user is provided in the stick 3 (one or both of the first stick 1 and the second stick 2), the operation information is input to the controller, and this information is stored in the internal memory so that the controller can read out this information at the time of control.

The setting part is not limited to have a configuration of setting the angles within the above predetermined ranges by the input from the operation part. The setting part may set the angles within the above predetermined ranges based on the inclinations θ1 and θ2 detected by the sensors 16 and 26 first when the user has grasped the grip parts 12 and 22.

The setting in the setting part may be based on the following values. That is, these values are the inclinations θ1 and θ2 detected by the sensors 16 and 26, and are the inclinations maintained within allowable error ranges (61a-61b and 62a-62b) for a predetermined period of time continuously first after the user grasps both the grip parts 12 and 22 (continuously detected inclinations). That is, the setting part may set the above angles within the predetermined ranges based on the continuously detected inclinations.

Further, since each user has a different symptom in his/her leg, the values of 61a, 61b, 62a, and 62b may be configured in such a way that they can be set in the internal memory. As described above, by determining the above angles within the predetermined ranges based on the angles at which the switches 13 and 23 are both turned on first after the user grasps the grip parts and the continuously detected angles, it is possible to prevent the above predetermined ranges from being set at an angle in the middle of the gripping the grip parts 12 and 22 and standing up. Further, while 61a=62a and 61b=62b are established, when a user who has only one diseased leg of the two legs is taken into account, these values may be configured in such a way that they can be set in the internal memory.

The control method of the stick 1 according to this embodiment includes a detection step and a control step. The above detection step is a step of detecting, by the sensors 16 and 26, the inclinations θ1 and θ2 of the stick 3. In the above control step, the controller 10 controls the drive part 15 and the drive part 25 in such a way that the inclinations θ1 and θ2 detected by the sensors 16 and 26 maintain angles between θ1a-θ1b and θ2a-θ2b, respectively.

While the above control method may be achieved, for example, using the aforementioned program for causing a computer included in the master side of the controllers 10 and 20 (one or both) of the stick 3 to execute the following processing, this embodiment is not limited thereto. The above processing includes a step of inputting the inclinations θ1 and θ2 detected by the sensors 16 and 26 and a step of controlling the drive part 15 and the drive part 25 in such a way that the input inclinations θ1 and θ2 maintain angles within predetermined ranges.

With reference to FIG. 5, an example of the above control method will be described. FIG. 5 is a flowchart for describing a processing example in the stick 3 according to this embodiment.

First, it is assumed that the controller 10 monitors the state of the switches 13 and 23 and the detection values (inclinations θ1 and θ2), which are output values from the sensors 16 and 26. The controller 10 determines whether or not the grasping operation by the user has been detected in both the switches 13 and 23 (Step S21). When the grasping operation has been detected, the processing proceeds to the following processing.

When it has been determined to be YES in Step S21 (when the grasping operation has been detected in both the switches 13 and 23), the controller 10 acquires these detection values (Step S22) and determines whether or not these detection values are constant (within the allowable error ranges) for a certain period (the above predetermined period of time) (Step S23). When it has been determined to be NO in Step S23, the processing returns to Step S21. When it has been determined to be YES in Step S23, the controller 10 determines the above angles within the predetermined ranges based on the detection values θ1 and θ2 of the sensors (or the median values or the average values within the above predetermined period of time), and sets the angles (Step S24).

After the above initial setting is performed, the controller 10 starts controlling the drive part 15 and the drive part 25 based on the detection values θ1 and θ2 of the sensors 16 and 26 and control the drive part 15 and the drive part 25 so as to maintain both the angles at the above angles within the predetermined ranges (Step S25). Next, the controller 10 determines whether or not the grasping operation has become undetected in at least one of the switches 13 and 23 (Step S26). When it has been determined to be YES, the controller 10 stops controlling the drive parts 15 and 25 (Step S27). Accordingly, the driving of the wheels 14 and 24 is stopped when the user no longer grasps at least one of the grip parts.

The above processing is repeated. That is, after Step S27, the processing starts again from Step S21.

With the stick 3 according to this embodiment, it becomes possible to assist walking by the power of the wheels 14 and 24 and to drive the wheels 14 and 24 according to user's desire regarding walking while maintaining the stick 3 at a stable posture. In particular, in the stick 3, the pair of sticks 1 and 2 are positioned on the right and left sides of the user, whereby the user is able to use the stick in a stable stick posture state while stabilizing the posture in the right-left direction. Further, in this embodiment, by setting the above angles within the predetermined ranges, the wheels 14 and 24 may be driven while maintaining the stick 3 at a stable posture in accordance with the operation setting by the user or the initial posture.

### Third Embodiment

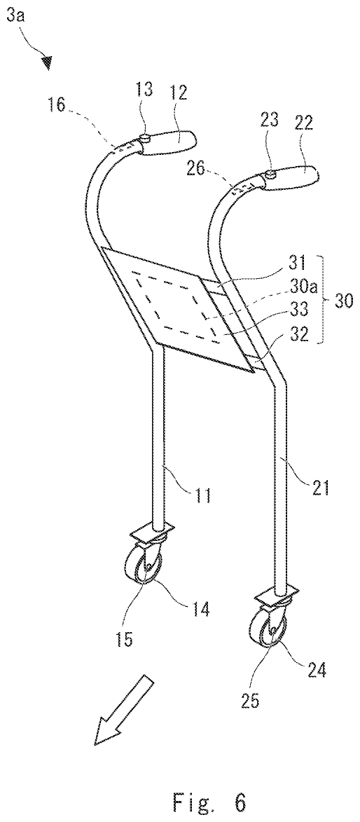

A third embodiment will be described with reference to FIG. 6. While this embodiment will be described, focusing mainly on the differences from the first embodiment, various application examples described in the first and second embodiments may be applied. FIG. 6 is a schematic perspective view showing one configuration example of a stick according to this embodiment.

A stick 3a according to this embodiment is a component in which the two sticks 1 and 2 according to the first embodiment are connected to each other, as shown in FIG. 6 (a component that includes a coupling part that couples the first stick 1 and the second stick 2). That is, the stick 3a according to this embodiment includes a coupling part 30 that couples the first stick that corresponds to the first stick 1 and the second stick that corresponds to the second stick 2.

The coupling part 30, which may include, for example, an upper coupling frame 31, a lower coupling frame 32, and a reinforcing plate 33 that is fixed to connect them, may further include a controller 30a that serves the functions of both the controllers 10 and 20. Since the coupling part 30 includes the controller 30a, it does not need to include the communication units 17 and 27. Both the coupling frames 31 and 32 may be fixed in such a way that they connect the body frame 11 and the body frame 21.

The shape of the coupling part 30 is not limited. Further, the coupling part 30 may include the controllers 10 and 20 as described in the first embodiment in the coupling part 30 or in the body frames 11 and 21, respectively in place of the controller 30a.

Further, in this embodiment, the coupling part 30 may be provided with a stress sensor and the controller 30a may perform drive control based on the stress that is generated in the coupling part 30 (an output value of the stress sensor). The controller 30a is able to control driving of the drive parts 15 and 25 so as to decrease the stress value when, for example, the output value of the stress sensor is large.

Alternatively, in this embodiment, the controller 30a is able to perform the drive control based on an angular difference (θ1−θ2) between sticks. While θ1 and θ2 are not shown in FIG. 6, they may be the angles as shown in FIGS. 1 and 3. In this case as well, an azimuth angle may be included as well. The controller 30a is able to perform the driving of the drive parts 15 and 25 so as to reduce, for example, the angular difference when the angular difference is large.

Further, the coupling part 30 may have a larger rigidity in the right-left direction than in the front-back direction when the user walks. Accordingly, the stress and the angular difference described above are likely to occur and a fine control can be performed.

As described above, the stick 3a according to this embodiment not only achieve the effects of the first and second embodiments but may be used as a walker for a user with a weaker leg since the stick 3a according to this embodiment includes the coupling part 30.

### ALTERNATIVE EXAMPLES

Next, alternative examples in the aforementioned first to third embodiments will be described.

The sticks 3 and 3a according to the aforementioned embodiments are not limited to the ones having the shapes, the structures, and the control examples illustrated in FIGS. 1-6, and may have other forms as long as they achieve functions of the respective parts. Further, the processes executed in the sticks 3 and 3a according to the embodiments (mainly the drive control of the drive parts 15 and 25) may be combined as appropriate.

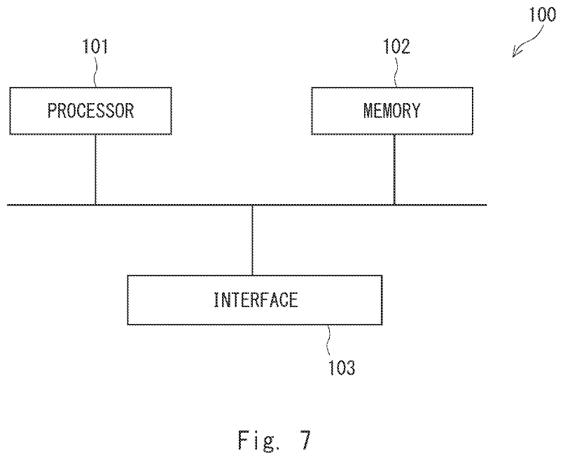

Further, the first stick 1 and the second stick 2 according to the first to third embodiments may both include, for example, the following hardware configuration. FIG. 7 is a diagram showing one example of a hardware configuration of a stick with a wheel.

A stick 100 with a wheel shown in FIG. 7 may include a processor 101, a memory 102, and an interface 103. For example, the interface 103 may include an interface with the drive part 15, an interface with the sensor 16, an interface with the switch 13, and a communication interface that corresponds to the communication unit. Note that the configuration of the interface 103 may vary depending on the embodiment.

The processor 101 may be, for example, a microprocessor, a Micro Processor Unit (MPU), a CPU or the like. The processor 101 may include a plurality of processors. The memory 102 is composed of, for example, a combination of a volatile memory and a non-volatile memory. The functions in the first stick 1 and/or the second stick 2 described in the first to third embodiments are achieved by the processor 101 loading a program stored in the memory 102 and executing the loaded program while exchanging necessary information via the interface 103. This program may be the one described in each of the embodiments. The other application examples have been described above and thus the descriptions thereof will be omitted.

The program can be stored and provided to a computer using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A stick comprising:
a first stick with a wheel and a second stick with a wheel,
wherein the first stick and the second stick are made to cooperate with each other to control driving of the respective wheels included in the first stick and the second stick.

2. The stick according to claim 1, wherein
the first stick includes a first grip part that a user grasps,
the second stick includes a second grip part that the user grasps,
the stick includes a switch that is provided in one of the first grip part and the second grip part, the switch being turned on when the user presses the switch by grasping the one of the first and second grip parts, and
the stick starts a drive control when the switch is turned on.

3. The stick according to claim 2, wherein the stick performs the drive control during a period in which the switch is in an ON state.

4. The stick according to claim 1, wherein
the first stick includes a first grip part that a user grasps and a first switch that is provided in the first grip part and is turned on when the user who grasps the first grip part presses the first switch,
the second stick includes a second grip part that the user grasps and a second switch that is provided in the second grip part and is turned on when the user who grasps the second grip part presses the second switch, and
the stick starts a drive control in accordance with an ON state of the first switch and the second switch.

5. The stick according to claim 4, wherein the stick starts the drive control when both the first switch and the second switch are turned on.

6. The stick according to claim 5, wherein the stick performs the drive control during a period in which both the first and second switches are in the ON state.

7. The stick according to claim 4, comprising
a setting part configured to disable one of the first switch and the second switch,
wherein the stick starts the drive control when all the effective switches of the first and second switches are turned on.

8. The stick according to claim 7, wherein the stick performs the drive control during a period in which all the effective switches are in the ON state.

9. The stick according to claim 1, wherein
the first stick includes a first sensor configured to detect inclination of the first stick,
the second stick includes a second sensor configured to detect inclination of the second stick, and
a drive control is performed based on the inclination detected by the first sensor and the inclination detected by the second sensor.

10. The stick according to claim 1, wherein the first stick and the second stick are connected to each other by a wired cable or wireless communication.

11. A method of controlling a stick, wherein
the stick includes a first stick with a wheel and a second stick with a wheel, and
the first stick and the second stick are made to cooperate with each other to control driving of the respective wheels included in the first stick and the second stick.

12. A non-transitory computer readable medium storing a program for causing a computer included in a stick to execute wheel driving processing, wherein
the stick includes a first stick with a wheel and a second stick with a wheel, and
in the wheel driving processing, the first stick and the second stick are made to cooperate with each other to control driving of the respective wheels included in the first stick and the second stick.
